(19) United States
(12) Patent Application Publication
(10) Pub. No.: US 2010/0227481 A1
(43) Pub. Date: Sep. 9, 2010

(54) COAXIAL CONNECTOR WITH A NEW TYPE OF CONTACT

(75) Inventors: CHI-NAN LIAO, Tu-Cheng (TW); JUI-KUANG CHUNG, Tu-Cheng (TW); HSIN-HSIEN YU, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/720,032

(22) Filed: Mar. 9, 2010

(30) Foreign Application Priority Data
Mar. 9, 2009 (TW) 98107553

(51) Int. Cl. H01R 12/00

(52) U.S. Cl. 439/63

(57) ABSTRACT

A coaxial connector for receipt of a central contact of a mating coaxial connector to be inserted therein comprises an insulative base defining a space section thereof, a mating section defined on the insulative base has a pin hole intercommunicating with the space section; a fixed contact and a movable contact essentially stacked in a vertical direction and received in the space section; the fixed contact are arranged to be sandwiched by the upper insulative base portion and the lower insulative base portion, the fixed contact has a planar contact part along a lengthwise direction; the movable contact has a base portion along the lengthwise direction, the base portion is retained by the upper and lower insulative base portion, a cantilever extends upwardly from the base portion and forms an acute angle thereof, the cantilever resists on the fixed contact, the movable contact further includes a soldering tail extending opposite to the cantilever; and wherein a pair of supporting arms extends symmetrically from the base portion into the space section, the supporting arms support the movable contact when the cantilever moves up and down for being pushed by the central contact of a mating coaxial connector.

### BACKGROUND OF THE INVENTION

1. Field of the Invention

The present invention relates to an electrical connector, especially to a coaxial connector having improved contact with supporting arms defined thereon.

2. Background of the Invention

Coaxial connectors are known to set up an electrical connection between an electronic component and a printed circuit board. U.S. Pat. No. 7,217,137 issued to Tsuyoshi Nakagawa discloses a type of connector mounted to a printed circuit board. The coaxial connector has a switch, which is to be mounted on a board, comprising: an insulated housing, which has a hole that can receive a center conductor of a coaxial plug; an outer conductor, which is provided outside of said insulated housing and can attach to/detach from the outer conductor of said coaxial plug; a stationary terminal and a movable terminal, which are provided below said hole and can contact to/be away from each other. Said stationary terminal has a contact section and said movable terminal has a securing section secured in said insulated housing and an elastic section that is arranged in said insulated housing through an insert hole provided in said insulated housing, extends like a cantilever from said securing section, and can touch the center conductor of said coaxial plug and contact with said contact section; and a covering section to cover said insert hole, said center conductor touches said elastic section when the center conductor of said coaxial plug fits to said hole of said insulated housing, and then said elastic section moves away from said contact section and the signal circuit will be switched.

Unfortunately, problems are encountered with the coaxial connectors mentioned above. The elastic section of the movable terminal is always damaged when being pushed by a center conductor of a coaxial plug and moving up and down. The stress released thereon is overloaded because the short arm of force.

Hence, an improved coaxial connector is needed to solve the above problem.

### SUMMARY OF THE INVENTION

An object, therefore, of the invention is to provide a new and improved coaxial connector of the character described able to provide a new type of movable terminal, thereby preventing the damaging of the elastic section of the.

In order to achieve the object set forth, a coaxial connector for receipt of a central contact of a mating coaxial connector to be inserted therein comprises an insulative base defining a space section thereof, a mating section defined on the insulative base has a pin hole intercommunicating with the space section; a fixed contact and a movable contact essentially stacked in a vertical direction and received in the space section; the fixed contact are arranged to be sandwiched by the upper insulative base portion and the lower insulative base portion, the fixed contact has a planar contact part along a lengthwise direction; the movable contact has a base portion along the lengthwise direction, the base portion is retained by the upper and lower insulative base portion, a cantilever extends upwardly from the base portion and forms an acute angle thereof, the cantilever resists on the fixed contact, the movable contact further includes a soldering tail extending opposite to the cantilever; and wherein a pair of supporting arms extends symmetrically from the base portion into the space section, the supporting arms support the movable contact when the cantilever moves up and down for being pushed by the central contact of a mating coaxial connector.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of the coaxial connector;

FIG. 2 is an exploded, perspective view of a coaxial connector embodying the concepts of the invention;

FIG. 3 is another exploded, perspective view of a coaxial connector;

FIG. 4 is a partly-exploded, perspective view of the coaxial connector of FIG. 2, showing contacts assembly including a fixed contact and a movable contact assembled at an initial position where a complementary coaxial connector is detached;

FIG. 5 is a perspective view of the movable contact of FIG. 2;

FIG. 6 is a cross-section of the coaxial connector shown in FIG. 1;

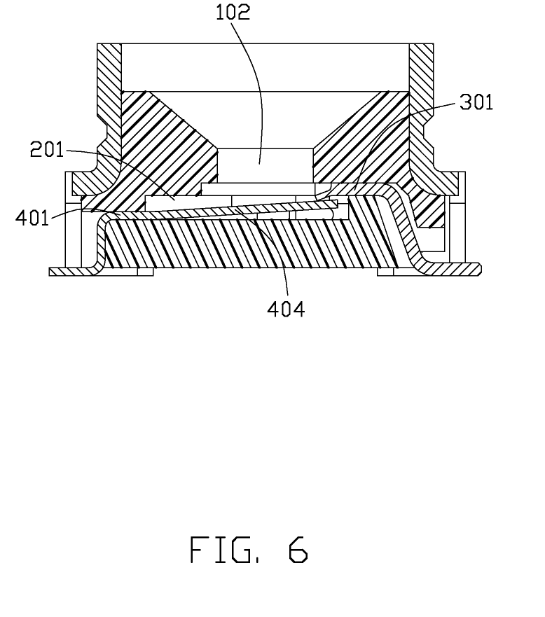

FIG. 7 is an assembled, perspective view of another preferred embodiment of the coaxial connector;

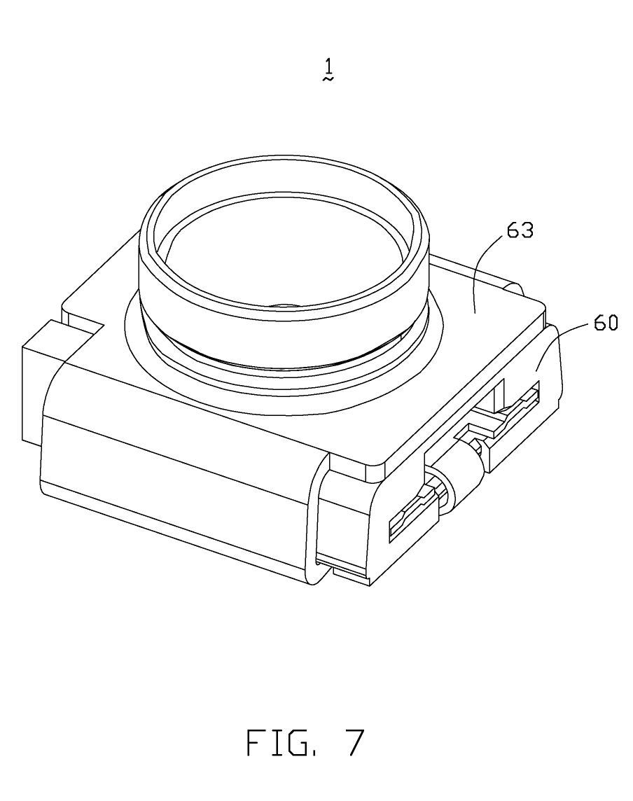

FIG. 8 is an exploded, perspective view of the coaxial connector shown in FIG. 7;

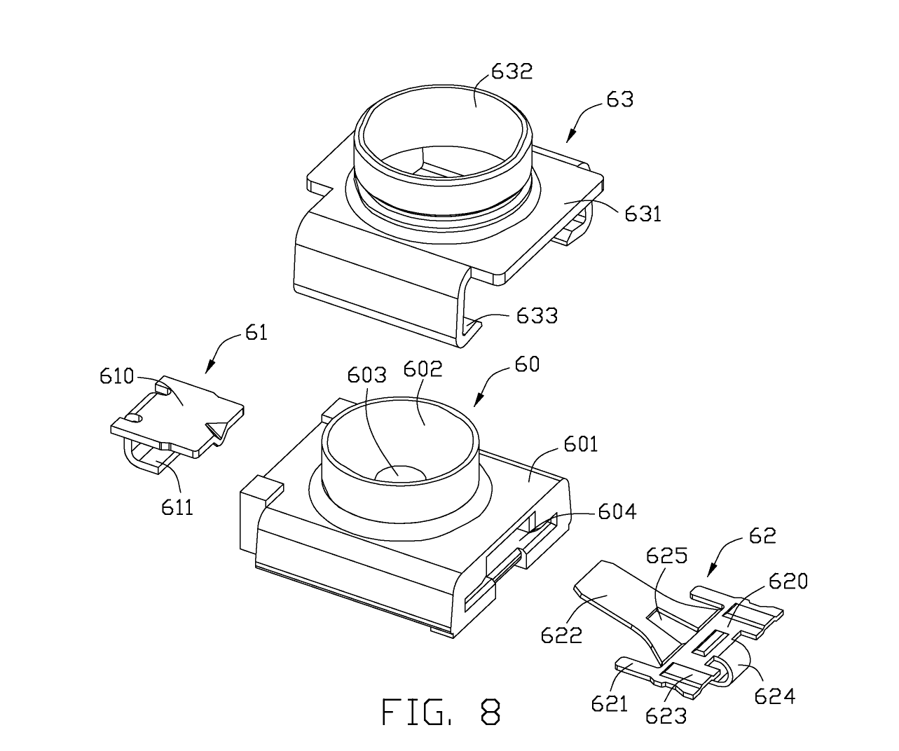

FIG. 9 is a partly-exploded, perspective view of the coaxial connector shown in FIG. 7;

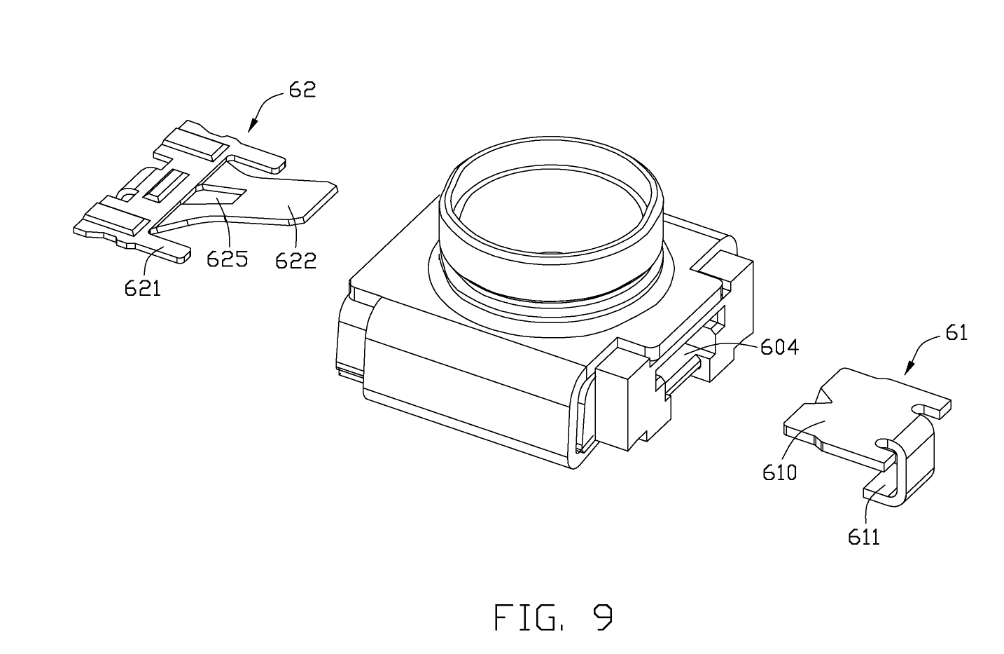

FIG. 10 is a perspective view of the movable contact of FIG. 8; and

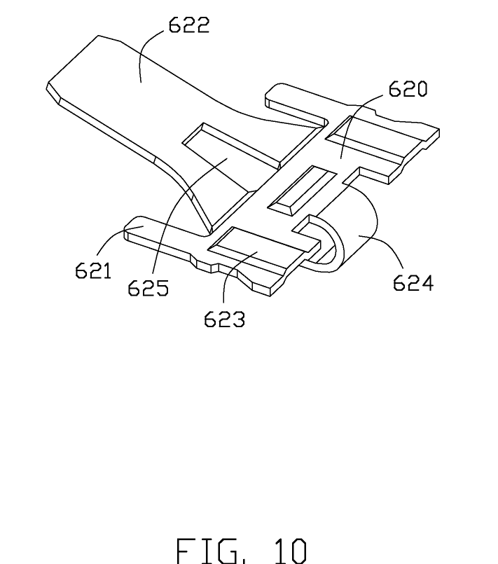

FIG. 11 is a cross-section of the coaxial connector.

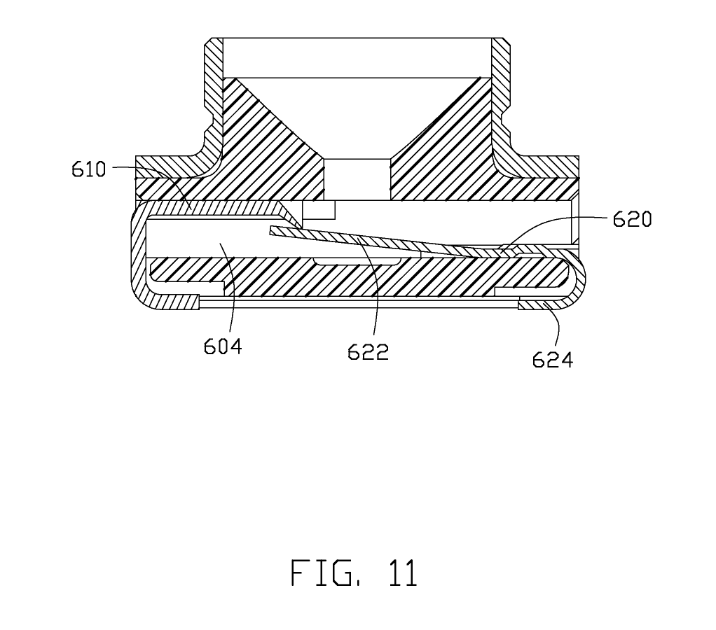

### DETAILED DESCRIPTION OF THE PREFERRED EMBODIMENT

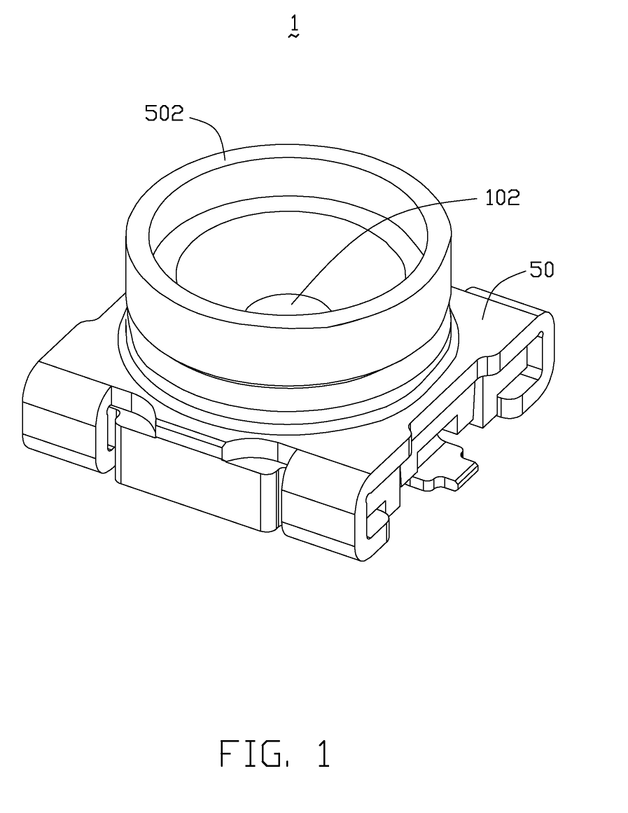

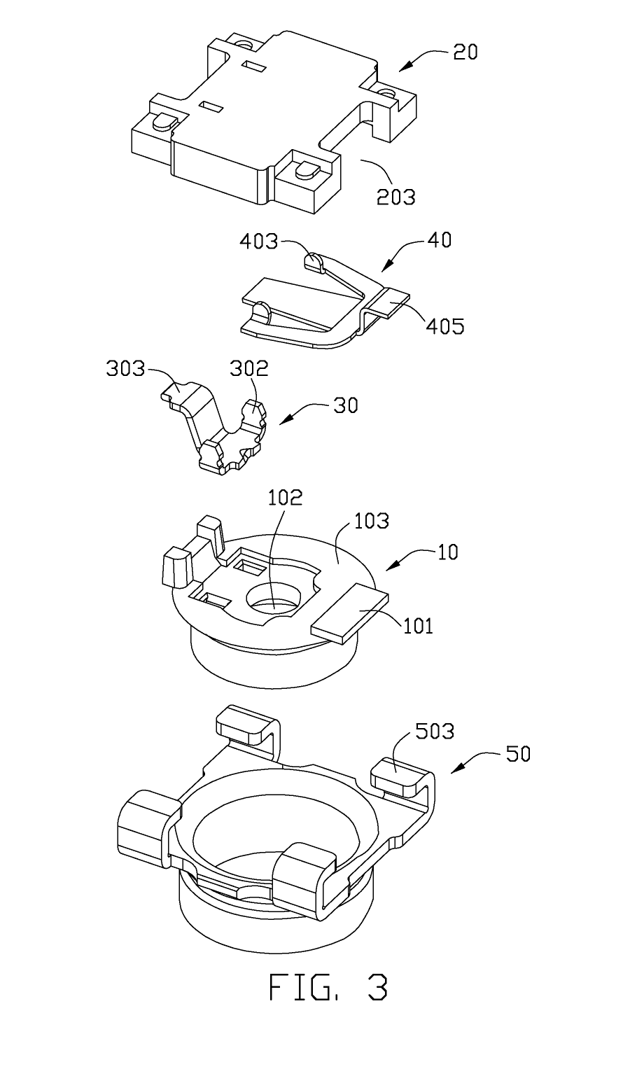

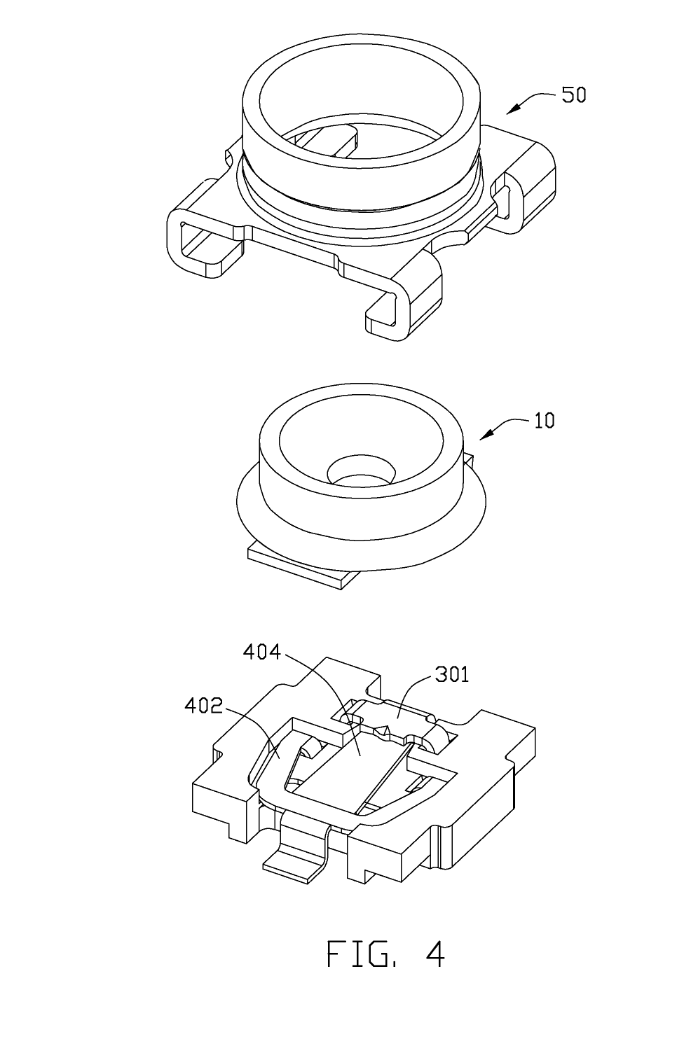

Referring to FIGS. 1-4, a coaxial connector 1 for receipt of a central contact of a mating coaxial connector to be inserted therein, comprises an insulative base including an upper insulative base portion 10 and a lower insulative base portion 20 with a space section 201, a fixed contact 30 and a movable contact 40 essentially stacked in a vertical direction and received in the space section 201, and a metal shell 50 shielding the insulative base.

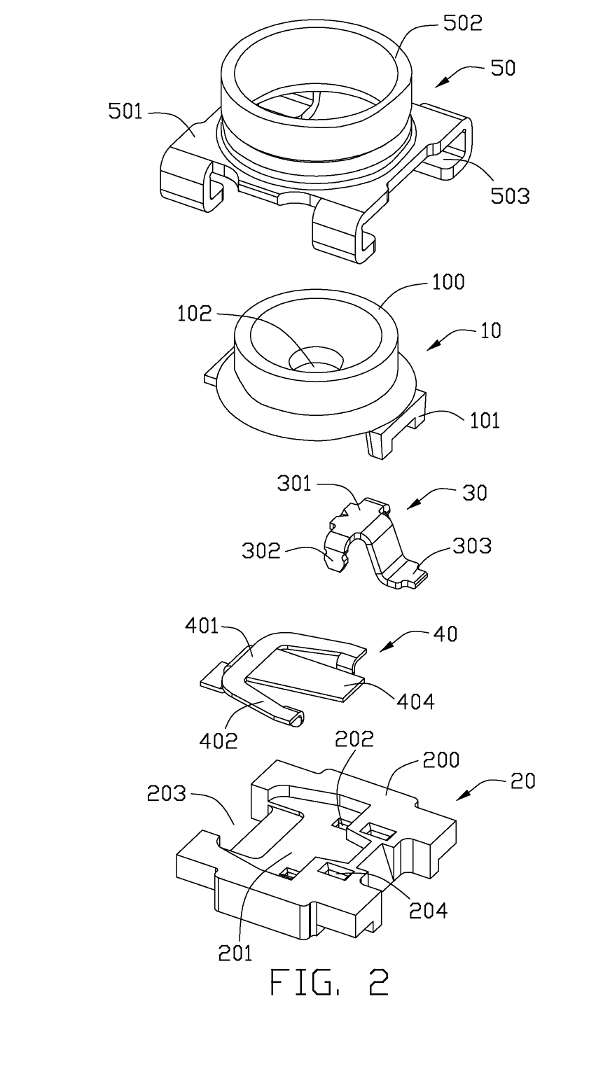

Referring to FIGS. 1-2, the upper insulative base portion 10 includes a mating section 100 with a pair of retention blocks 101 defined on a bottom surface 103 symmetrically. A pin hole 102 for receiving the contact of the mating coaxial connector runs through the upper insulative base portion 10 along a direction which is perpendicular to the bottom surface 103.

The lower insulative base portion 20 includes a base section 200 having a space section 201 for receiving the fixed contact 30 and the movable contact 40 stacked in a vertical direction in the space section 201, which reduces a transverse width of the space section 201 and thereby achieves a mini-connector. A pair of cavities 202 is defined on the bottom of the space section 201 to brace supporting pads 403 of the movable contact 40 to a level at which a cantilever 404 of the movable contact 40 will come in contact with the fixed contact 40. Two cutouts 203 are separately defined on two opposite sides of the lower insulative base portion 20 to cooperate with the retention blocks 101 to hold the fixed contact 30 in position. A pair of depressions 204 is defined on a side of the lower insulative base portion 20 for the fixed contact 30 to be retained therein.

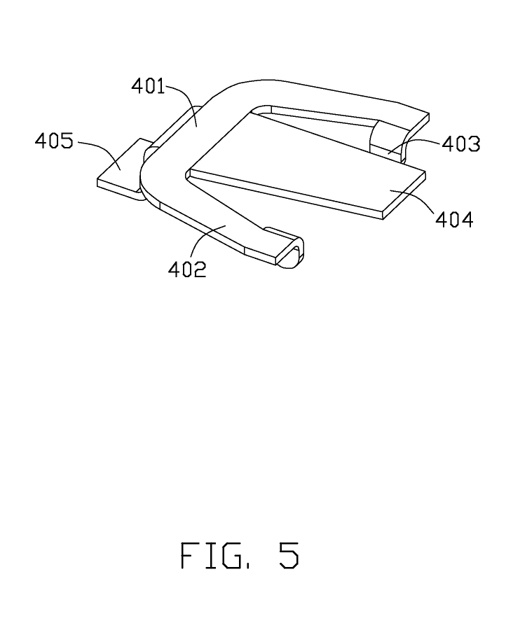

Referring to FIG. 1, FIG. 2 and FIG. 5, the fixed contact 30 is arranged to be sandwiched by the upper insulative base portion 10 and the lower insulative base portion 20. The fixed contact 30 has a planar contact part 301 along a lengthwise direction thereof; a pair of retention legs 302 is defined on the two free ends of the planar contact part 301, and an extending tail 303 extends from another side of the planar contact part 301. The extending tail 303 is received in one of the cutout 203.

The movable contact 40 has a base portion 401 extends along the lengthwise direction, a pair of supporting arms 402 extend from two opposite ends of the base portion 401, each supporting arms 402 defines a supporting pad 403 extending downwardly from an inner side thereof. The supporting pads 403 are retained by the cavities 202. A cantilever 404 extends from the base portion 401 upwardly and locates between the pair of supporting arms 402. An acute angle is defined between the cantilever 404 and the base portion 401 to make sure that the cantilever 404 can be elastic when pushed by a center conductor of a coaxial plug (not shown). A soldering tail 405 extends from a side opposite to the cantilever of the base portion 401.

A metal shell 50 having planar section 501 with a mating promenency 502 protruding therefrom. A plurality of locking barbs 503 is defined on the opposite sides of the planar section 501 symmetrically.

After assembly, the movable contact 40 is received in the space section 201. The cantilever 404 elastically resist on a under face of the planar contact part 301. The supporting pads 403 receive in the cavities 202 for locating the movable contact 40 and supporting the movable contact 40 when the cantilever 404 is pushed by the center conductor of a coaxial plug.

Another preferred embodiment of the coaxial connector comprises an insulative base 60; a fixed contact 61 and a movable contact 62 essentially inserted thereinto in a horizontal direction and received in the space section 602; and a metal shell 63 shielding the insulative base 60.

The insulative base 60 has a base section 601 with a mating section 602 defined thereon. A pin hole 603 runs through the mating section 602 from the top down and intercommunicates with a space section 604 in the base section 601. The space section 604 runs through the base section 601 along a horizontal direction.

The fixed contact 61 is arranged to be retained by the base section 601 of the insulative base 60. The fixed contact 61 has a planar contact part 610 inserted into the space section 604. A soldering tail 611 is defined on one side of the planar contact part 610. The movable contact 62 has a base portion 620 extending along a lengthwise direction. A pair of supporting arms 621 is defined on two opposite ends of the base portion 620 and extends to the space section 604. A cantilever 622 extends from the base portion 620 upwardly and locates between the pair of supporting arms 621. A soldering tail 624 extends from the base portion 620 opposite to the cantilever 622. An acute angle is defined between the cantilever 622 and the base portion 620 to make sure that the cantilever 622 can be elastic when pushed by a center conductor of a coaxial plug (not shown). Protrusions 623 protrude from a top face of the base portion 620 for retaining the base portion 620 in the space section 604. A cutout 625 is defined on the cantilever 622 adjacent to the base portion 620 for decreasing the stress released thereon.

A metal shell 63 having planar section 631 with a mating permanency 632 protruding therefrom. A plurality of locking barbs 633 is defined on the opposite sides of the planar section 631 symmetrically.

The two embodiments of the invention show that the arm of force of movable contact is elongated because of the supporting arms and the supporting pads. When the cantilever is pushed by a center conductor of a coaxial plug, the short arm of force is helpful to reducing the stress released on the base portion.

While preferred embodiment in accordance with the present invention have been shown and described, equivalent modifications and changes known to persons skilled in the art according to the spirit of the present invention are considered within the scope of the present invention as defined in the appended claims.

What is claimed is:

1. A coaxial connector for receipt of a central contact of a mating coaxial connector to be inserted therein, comprising:
an insulative base defining a space section thereof, a mating section defined on the insulative base having a pin hole intercommunicating with the space section;
a fixed contact and a movable contact essentially stacked in a vertical direction and received in the space section;
the fixed contact arranged to be sandwiched by the upper insulative base portion and the lower insulative base portion, the fixed contact having a planar contact part along a lengthwise direction;
the movable contact having a base portion along the lengthwise direction, the base portion being retained by the upper and lower insulative base portion, a cantilever extending upwardly from the base portion and forming an acute angle thereof, the cantilever resisting on the fixed contact, the movable contact further including a soldering tail extending opposite to the cantilever; and
wherein a pair of supporting arms extend symmetrically from the base portion into the space section, the supporting arms support the movable contact when the cantilever moving up and down for being pushed by the central contact of a mating coaxial connector.

2. The coaxial connector as recited in claim 1, wherein the insulative base further includes an upper insulative base portion and a lower insulative base portion.

3. The coaxial connector as recited in claim 1, wherein a pair of depressions is defined in the insulative base, a pair of retention legs defined on the planar contact part of the fixed contact retains in the depressions correspondingly.

4. The coaxial connector as recited in claim 2, wherein a pair of cutouts is defined on two opposite sides of the insulative base.

5. The coaxial connector as recited in claim 4, wherein a pair of retention blocks is defined on the upper insulative base portion to cooperate with the cutouts interferentially.

6. The coaxial connector as recited in claim 1, wherein a supporting pad is defined on the end of each supporting arm extending downwardly.

7. The coaxial connector as recited in claim 6, wherein a pair of cavities is defined on the bottom of the space section and retains the supporting pads of the movable contact.

8. The coaxial connector as recited in claim 1, wherein the electrical connector further includes a metal shell with a plurality of locking barbs defined thereof.

9. A coaxial connector for mounting to the printed circuit board, comprising:
an insulative housing defining a space section;
a fixed contact retained to the housing, the fixed contact having a contact section disposed in the space section and a tail section for connecting to said printed circuit board;
a moveable contact up and down moveably disposed in the space section having a pair of supporting pads retained in a bottom face of the space section, a contact section selectively engaging the fixed contact; and
an upper base mounted upon the housing not only defining a plug passageway therethrough but also preventing upward withdrawal of the moveable contact from the space section; wherein
said plug passageway allows a plug to be inserted therethrough and invade the space section to not only mechanically and electrically engage the moveable contact to electrically connect to the fixed contact but also disengage the movable contact from the fixed contact.

10. The coaxial connector as claimed in claim 9, further including a shell enclosing said insulative housing.

11. The coaxial connector as claimed in claim 9, wherein a pair of cavities is defined in the bottom face of the space section and receives the supporting pads correspondingly.

12. The coaxial connector as claimed in claim 9, wherein the insulative housing includes an upper base and a lower base.

13. The coaxial connector as claimed in claim 12, wherein the upper base is equipped with an outwardly projecting retention block to protect a tail section of the movable contact.

14. The coaxial connector as claimed in claim 9, wherein said moveable contact defines a base portion along a horizontal direction received in the space section, a pair of supporting arms extends from two opposite ends of the base portion, one of the supporting pad is defined on an end of each supporting arm downwardly.

15. A coaxial connector comprising:
an insulative bottom base portion;
a stationary contact and a moveable contact assembled to an upper face of the bottom base portion;
an insulative upper base portion assembled upon the bottom base portion and cooperating with said bottom base portion to sandwich said stationary contact and said moveable contact therebetween in a vertical direction;
a metallic shell assembled to the bottom base portion and cooperating with said bottom base portion to sandwich said upper base portion therebetween in said vertical direction,
said stationary contact located on a first side of the bottom base portion, said movable contact located on a second side of the bottom base portion opposite to said first side, said moveable contact including a deflectable cantilever contacting section extending toward the stationary contact; wherein
said moveable contact is further equipped with a pair of supporting arms which are located by two sides of said cantilever contacting section and share a same root region with the cantilever contacting section; wherein
a pair of securing sections are formed either around said root region or distal ends of the supporting arms to secure said pair of supporting arms to the bottom base portion.
